(19) United States
(12) Patent Application Publication
(10) Pub. No.: US 2010/0040127 A1
(43) Pub. Date: Feb. 18, 2010

(54) CIRCUIT CONFIGURATION FOR DATA COMBINING

(76) Inventor: Chao-Kai Wen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/189,799

(22) Filed: Aug. 12, 2008

(51) Int. Cl. H04L 27/01

(52) U.S. Cl. 375/232

(57) ABSTRACT

A receiving end apparatus disposes a spatial data combining circuit at symbol level and disposes an HARQ data combining circuit and/or the repetition data combining circuit at bit level. The spatial data combining is performed before the de-mapping, while the de-repetition and/or the HARQ chase combining are performed after the de-mapping. This apparatus configuration can significantly reduce the buffer size and the computation complexity required so the overall performance is therefore improved.

### BACKGROUND

The present invention relates to a circuit configuration for data combining, and more particularly, to a circuit configuration that reduces the buffer size and computation complexity for data combining.

In order to increase the reliability of a data burst transmission in wireless fading channels, a wide variety of diversity utilization schemes have been proposed to deal with fading channels. Time diversity, which can be achieved by transmitting multiple copies of data through time varying channels, is one of the most promising diversity utilization techniques for use in WiMAX systems. The time diversity scheme benefits from diversity gain generated by combining data received from a plurality of independent and uncorrelated channels.

Hybrid automatic repeat-request (HARQ) algorithm is a well-known scheme that applies time diversity: it uses a forward error correcting (FEC) code in conjunction with a retransmission scheme. When a received packet is found to have uncorrectable errors, the HARQ scheme may discard the received packet and request a retransmission (type I HARQ), or store the received packet, request a retransmission and combine the packets received in these two transmissions (type II HARQ).

In addition to the time diversity scheme, the spatial diversity scheme, such as the multi-input multi-output (MIMO) system, is also known for its higher link reliability. In the MIMO diversity system, a single stream is emitted from each of the transmitting antennas with space-time coding. By utilizing multiple antennas at both the transmitter and receiver, the MIMO diversity system can improve communication performance, allowing higher spectral efficiency and link reliability.

When designing a receiving end, however, the spatial diversity scheme and the time diversity scheme are always considered separately. Since there is no explicit research on how to integrate the spatial diversity with the time diversity in order to gain the most advantage from both, the receiving end is not capable of reaching a best overall performance.

### SUMMARY

One objective of the present invention is therefore to provide a circuit configuration that properly constructs circuits of different diversity schemes. The spatial data combining is performed at a symbol level while the time-diversity data combining (for example, the HARQ data combining or the repetition data combining) is performed at a bit level. The circuit configuration can reduce the buffer size and computation complexity required; the overall performance is therefore improved.

According to one exemplary embodiment of the present invention, an apparatus for re-generating data from at least one received signal is disclosed. The apparatus comprises at least one equalizer, a de-mapper, a level adjuster, and a combining circuit, wherein the equalizer equalizes a received signal to generate an equalized signal, and the de-mapper, coupled to the equalizer, is utilized to de-map the equalized signal to generate a set of values representing data embedded in the received signal. The output of the de-mapper is delivered to the level adjuster in order to generate an adjusting factor according to a noise level of the received signal, and adjust the set of values according to the adjusting factor to generate a set of adjusted values. The combining circuit, coupled to the level adjuster, then performs a data combining on the set of adjusted values to re-generate the data embedded in the received signal.

According to another exemplary embodiment of the present invention, a method of re-generating data from at least one received signal is disclosed. The method comprises equalizing at least one received signal to generate at least an equalized signal, de-mapping the equalized signal to generate a set of values representing data embedded in the received signal, generating an adjusting factor according to a noise level of the received signal, adjusting the set of values according to the adjusting factor to generate a set of adjusted values, and performing a data combining on the set of adjusted values to re-generate the data embedded in the received signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a receiving-end circuit structure according to one exemplary embodiment of the present invention.

FIG. 2 shows a table listing the buffer size and complexity comparison between the bit-level spatial data combining and the symbol-level spatial data combining according to one exemplary embodiment of the present invention.

FIG. 3 is a diagram of a receiving-end circuit structure according to another exemplary embodiment of the present invention.

FIG. 4 shows a table listing the buffer size comparison between the bit-level HARQ chase combining and the symbol-level HARQ chase combining according to one exemplary embodiment of the present invention.

FIG. 5 is a diagram of the first computing unit according to one exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

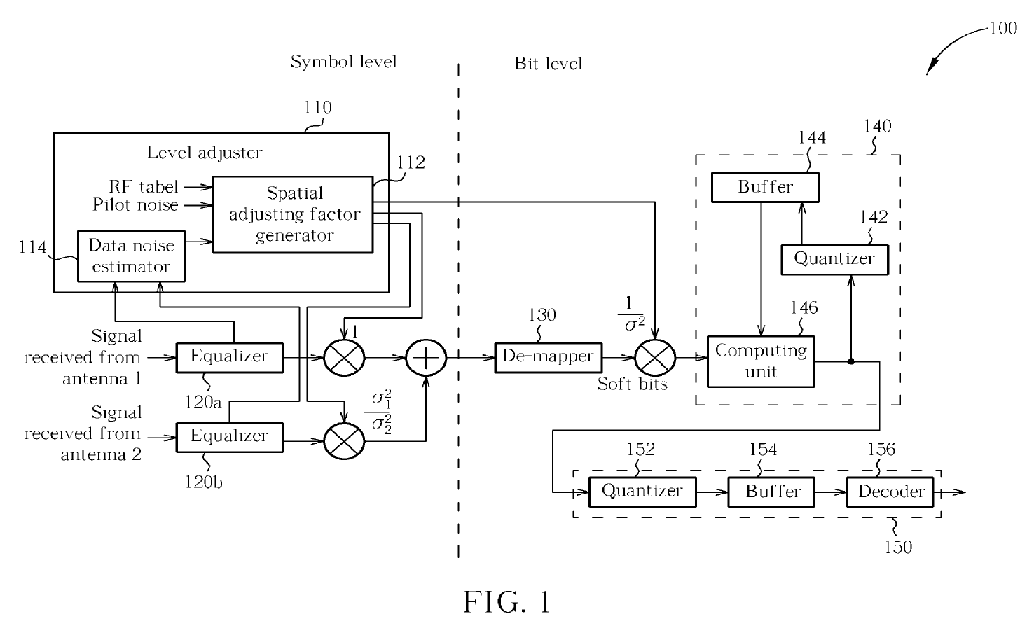

In order to achieve a better overall performance, a circuit structure for data combining proposed herein includes a spatial data combining circuit operating at a symbol level and a time data combining circuit operating at a bit level; that is, the process of the spatial data combining takes a “symbol” as a unit, while the process of the time data combining takes a “bit” as a unit. Please refer to FIG. 1, which is a diagram of a receiving-end circuit structure according to one exemplary embodiment of the present invention. The receiving-end 100 includes a level adjuster 110, at least one equalizer 120 (in this embodiment, two equalizers 120a and 120b are shown as an example), a de-mapper 130, a combining circuit 140, and a decoding circuit 150. Those familiar to this art should understand that some blocks, such as blocks for sub-carrier de-randomization and de-permutation, are omitted here for brevity. When receiving signals from antennas, the level adjuster 110 generates adjusting factors according to noise levels of the received signals. The equalizers 120a and 120b are in charge of equalizing the fading channel effects on the received signals to generate equalized signals, which are then summed up in a weighted way and de-mapped by the de-mapper 130 to generate a set of values (i.e. soft bits) representing data embedded in the received signals (note that this embodiment is based on the time diversity MIMO system, and the signals received from different antennas correspond to the same transmitted data). Therefore, the operations prior to the de-mapper 130 (e.g. the equalizing and the spatial data combining) act at the symbol level, and the operations posterior to the de-mapper 130 act at the bit level.

In this embodiment, the equalizers 120a and 120b first respectively generate the required channel responses, and then respectively store the power of the channel state information (CSI) and the equalized signals into a buffer (not shown). Each buffer has a size sufficient to contain the information of a plurality of sub-carriers, and provides the equalized data to the level adjuster 110 for noise level estimation. After the noise level of each equalized signal has been estimated, a spatial adjusting factor generator 112 of the level adjuster 110 generates the adjusting factors according to the noise levels, and adjusts the equalized signals according to the adjusting factors in order to adjust the signal level. In this embodiment, the first equalized signal output from the equalizer 120a is multiplied by 1, and the second equalized signal output from the equalizer 120b is multiplied by a factor of

$$\frac{{σ}_{1}^{2}}{{σ}_{2}^{2}} ,$$

where σ₁² represents the noise variance of the first equalized signal, and σ₂² represents the noise variance of the second equalized signal. In this way, the summed signal can have a maximal signal-to-noise ratio (SNR). Note that the above-mentioned factors provided by the level adjuster 110 are for illustrative purposes only, and should not be taken as limitations of the present invention. For example, multiplying the first equalized signal by

$$\frac{1}{{σ}_{1}^{2}}$$

and multiplying the second equalized signal by

$$\frac{1}{{σ}_{2}^{2}}$$

can achieve substantially the same result.

As mentioned above, the summed signal is de-mapped by the de-mapper 130, and the soft bits (log likelihood ratio values) representing data embedded in the received signals are generated. The level adjuster 110 further adjusts the soft bits according to a noise level of the transmission; for example, the level adjuster 110 multiplies the soft bits by a reciprocal of the overall noise variance of the equalized signals. The meaning of this adjustment is to reflect potential of this transmission, and reduce the bit width of the decoder input. The reference sources for the level adjuster 110 to estimate the noise variance include an RF error vector magnitude (EVM) table, pilot bits and data bits of the received signals in this embodiment. The noise level estimated from the pilot bits can provide a high accuracy, the data bits can be used to derive the true noise level by a data noise estimator 114, and the RF EVM table can be an auxiliary choice if both noise levels estimated from the pilot bits and the data bits are not available.

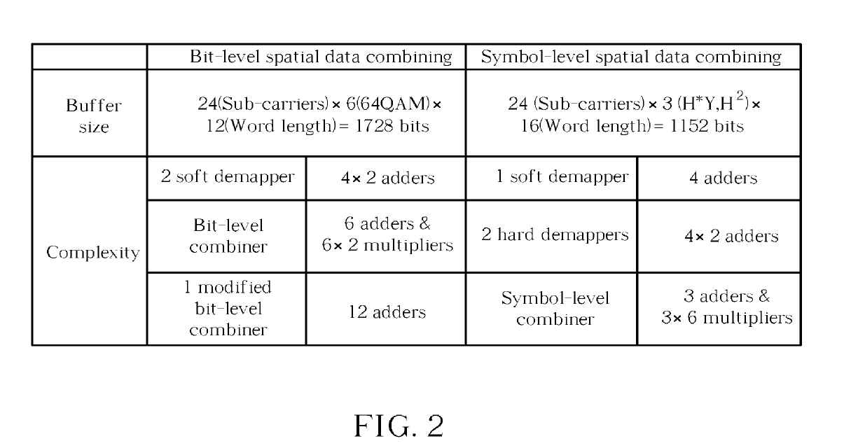

Disposing the equalizers 120a, 120b, and the level adjuster 110 prior to the de-mapper 130 allows the receiving-end circuit structure 100 to be provided with the advantages of reduced buffer size and computation complexity. Taking a WiMAX system applying 64 QAM as an example, when the spatial data combining is performed at symbol level, the required buffer size in an equalizer is 1152 bits since there are 24 sub-carriers, and the buffer needs to store 3 words including the power of the CSI and the equalized signal for each sub-carrier, wherein each word has a length of 16 bits. If the spatial data combining is performed at bit level, however, the required buffer size in an equalizer will increase to 1728 bits since the buffer needs to store 6 words for 64 QAM for each sub-carrier, wherein each word has a length of 12 bits. Moreover, the symbol level spatial data combining needs fewer adders and multipliers than the bit level spatial data combining, which means that the circuit complexity and the computation complexity are decreased. FIG. 2 shows a table listing the buffer size and complexity comparison between the bit level spatial data combining and the symbol level spatial data combining according to the above conditions.

The soft bits after adjustment by the adjusting factor are sent to the combining circuit 140 so long as the soft bits have a repetition characteristic (that is, the FEC code has a repetition function). The combining circuit 140 performs a data combining that is able to cancel the repetition function on the adjusted soft bits to re-generate the data embedded in the received signal. More specifically, the adjusted soft bits are first quantized by a quantizer 142 of the combining circuit 140 since the precision required for de-repetition is not as high as that required for equalization and de-mapping. The quantizer 142 is an optional element, however. A slot of the FEC block of the adjusted soft bits is stored in a repetition buffer 144 to wait for the next repetition slot, and a computing unit 146 of the combining circuit 146 performs a de-repetition on the slot buffered in the repetition buffer 144 and the next slot. After all the combining is complete, the generated data is sent to the decoding circuit 150 to check its correctness.

In the decoding circuit 150, the adjusted soft bits received from the combining circuit 140 are quantized by a quantizer 152 and then stored in a buffer 154 to wait for decoding by a decoder 156. This is due to the adjusting factor of the level adjuster 110 that enables the bit width of the decoder 156 to be reduced. The decoding should be started when all the soft bits of the FEC block are stored in the buffer 154, and if the decoder 156 determines that the correctness of the soft bits is doubtful, the receiving end 100 may request a retransmission to the transmitter.

If the soft bits outputted from the de-mapper 130 do not have the repetition characteristic, however, (i.e. the FEC code does not have the repetition function), the soft bits after adjustment by the adjusting factor are sent to the decoding circuit 150 directly to check their correctness. Moreover, the combining circuit 140 can be utilized as an HARQ combining circuit, and the adjusted soft bits that fail to pass the correctness examination are buffered in the HARQ combining circuit 140 to wait for a retransmission.

The retransmission is controlled by the base station with an ARQ channel identification (ACID) and AI_SN fields in the downlink MAC and uplink MAC. Each HARQ channel indicated by a specific ACID is managed separately, and the retransmission can be recognized if the AI_SN field in the HARQ channel remains the same between two HARQ burst allocations. Therefore, when a retransmission signal is received, it is equalized, de-mapped and level adjusted as mentioned above, and the set of soft bits corresponding to the retransmission signal are sent to the HARQ combining circuit 140. The computing unit 146 then performs a combining (for example, the chase combining) on two transmissions to improve the performance of decoding. Note that the level adjustment that adjusts the soft bits corresponding to the retransmission signal according to an overall noise level of the retransmission makes the soft bits corresponding to the retransmission signal have a same SNR level as the soft bits stored in the HARQ buffer 144; that is, a different noise level added to each signal during transmission is equalized, and the potential of each transmission is reflected.

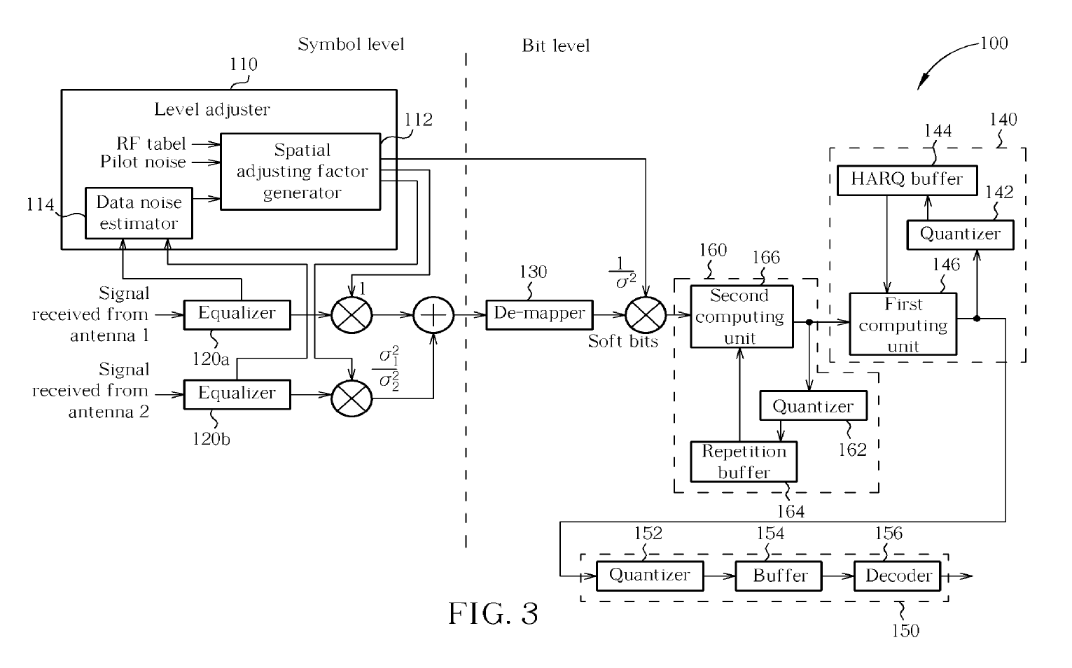

In another embodiment, as shown in FIG. 3, the receiving end 100 is provided with both a repetition combining circuit 160 and an HARQ combining circuit 140 at the bit level. The second computing unit 166 of the repetition combining circuit 160 performs a de-repetition on the adjusted bits received from the de-mapper 130 and adjusted bits stored in the repetition buffer 164 before they are sent to the HARQ combining circuit 140 for chase combining. Similarly, the quantizers 162 and 142 are utilized to reduce bit width of the values stored in the repetition buffer 164 and the HARQ buffer 144 respectively, and are optional elements.

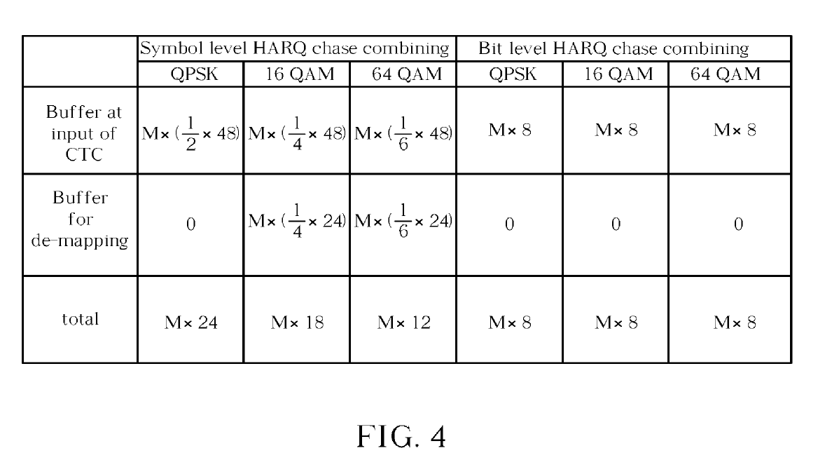

In the above embodiments, disposing the repetition combining and the HARQ chase combining at bit level helps the receiving end 100 further reduce the buffer size. Please refer to FIG. 4, which shows a table listing the buffer size required for the symbol-level HARQ chase combining and the bit-level HARQ chase combining, wherein M represents the number of coded bits. As can be seen, the buffer size for the bit-level HARQ chase combining is much less than the symbol-level HARQ chase combining no matter which modulation scheme is adopted.

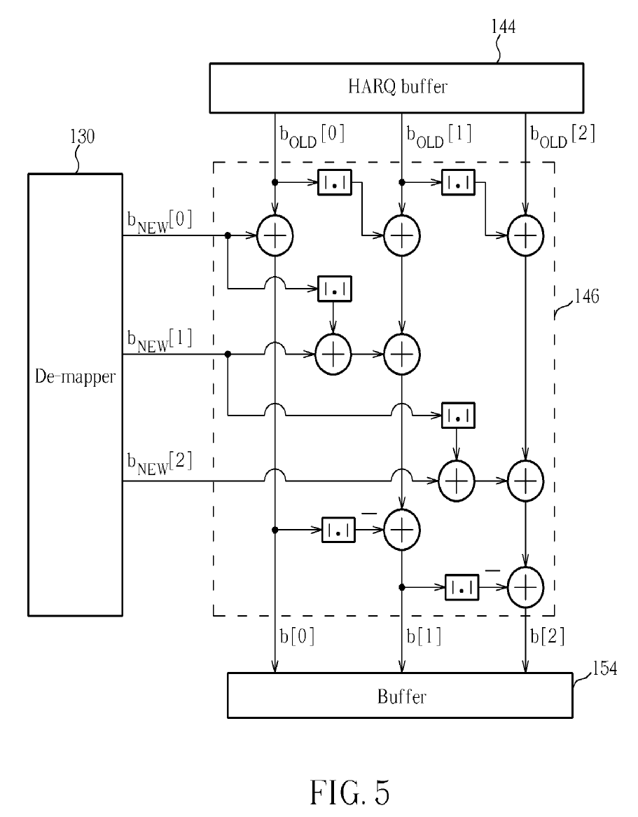

However, as the packet size or the number of the retransmission increases, the bit-level chase combining may induce performance loss, and the packet error rate (PER) of symbol-level chase combining may become lower than that of bit-level chase combining. In order to simultaneously reach the advantages of reduced buffer size and good performance (e.g. low PER), the first computing unit 146 is modified to compensate for the performance loss: the first computing unit 146 generates a first bit of output data according to a first bit of the set of buffered values and a first bit of the set of values corresponding to the retransmission signal, and generates an n^{th} bit of the output data according to an n^{th} bit and an (n−1)^{th} bit of the set of buffered values, an n^{th} bit and an (n−1)^{th} bit of the set of values corresponding to the retransmission signal, and an (n−1)^{th} bit of the output data of the first computing unit 146, where n is an integer larger than 1. Please refer to FIG. 5, which is a diagram of the first computing unit 146 according to one exemplary embodiment of the present invention. Please note that this embodiment only illustrates three bits (the real part of 64 QAM) as example, but a skilled person should appreciate how to extend the structure to a practical use after reading the disclosure. In FIG. 5, b[0]−b[2] represent output data of the first computing unit 146, and will be stored into the buffer 154 (the quantizer 152 is omitted here for simplicity), the old bits b_{OLD}[0]−b_{OLD}[2] represent bits stored in the HARQ buffer 144, and the new bits b_{NEW}[0]−b_{NEW}[2] represent bits output by the de-mapper 130 or the repetition combining circuit 160 depending on the structure of the receiving end 100 (please note that, in actuality, the new bits are adjusted by the level adjuster 110 before they are sent to the first computing unit 146, but this adjustment is omitted here for brevity). The operation of the first computing unit 146 can be expressed by the following equations, where X represents the transmitted signal, H represents the channel response, Z represents the noise added to the transmitted signal, and Y represents the received signal:

Y=HX+Z,

G=|H|², F=H*Y=|H|²X+H*Z,

b_{OLD}[0]=R(F_{OLD}), b_{OLD}[1]=4G_{OLD}−|R(F_{OLD})|, b_{OLD}[2]=2G_{OLD}−|b_{OLD}[1]|,

b_{NEW}[0]=R(F_{NEW}), b_{NEW}[1]=4G_{NEW}−|R(F_{NEW})|, b_{NEW}[2]=2G_{NEW}−|b_{NEW}[1]|,

b[0]=b_{OLD}[0]+b_{NEW}[0],

b[1]=b_{OLD}[1]+b_{NEW}[1]+|b_{OLD}[0]|+|b_{NEW}[0]|−|b[0]|,

b[2]=b_{OLD}[2]+b_{NEW}[2]+|b_{OLD}[1]|+|b_{NEW}[1]|−|b[1]|.

By applying this rule to the first computing unit 146, the modified bit-level HARQ chase combining can achieve the same performance as the symbol-level HARQ chase combining. Therefore, the receiving end 100 can gain the most advantage from both the spatial diversity and time diverity schemes, and reach a best overall performance. Moreover, although the above embodiments use MIMO system to raise the link reliability, the receiving end may have only one antenna to receive signals in other embodiments. In this situation, there will be only one equalizer 120 and the weighting adjustment performed on the equalized signals of the equalizer 120a and 120b may not be necessary; in other words, the spatial adjusting factor generator 112 may only adjust the output of the de-mapper 130 according to the adjusting factor corresponding to the noise level of the received signal. As long as the spatial data combining is performed at a symbol level while the time-diversity data combining is performed at a bit level, the circuit structure still obeys the spirit of the present invention.

Those skilled in the art will readily observe that numerous modifications and alterations of the device and method may be made while retaining the teachings of the invention.

What is claimed is:

1. An apparatus for re-generating data from at least one received signal, comprising:
at least one equalizer, for equalizing a received signal to generate an equalized signal;
a de-mapper, coupled to the equalizer, for de-mapping the equalized signal to generate a set of values representing data embedded in the received signal;
a level adjuster, coupled to the de-mapper, for generating an adjusting factor according to a noise level of the received signal, and adjusting the set of values according to the adjusting factor to generate a set of adjusted values; and
a combining circuit, coupled to the level adjuster, for performing a data combining on the set of adjusted values to re-generate the data embedded in the received signal.

2. The apparatus of claim 1, comprising a plurality of equalizers each for equalizing a received signal received by an antenna to generate an equalized signal, where at least one equalized signal output from at least one equalizer is adjusted by the level adjuster according to the noise level before being combined with at least one other equalized signal and sent to the de-mapper.

3. The apparatus of claim 1, wherein the level adjuster generates the adjusting factor according to the noise level derived from an RF error vector magnitude (EVM) table, pilot bits and data bits of the received signal.

4. The apparatus of claim 1, wherein the adjusting factor is a reciprocal of a noise variance, and the level adjuster generates the set of adjusted values by multiplying the set of values by the adjusting factor.

5. The apparatus of claim 1, wherein the combining circuit comprises:
a repetition buffer, coupled to the level adjuster, for buffering the set of adjusted values; and
a computing unit, coupled to the repetition buffer and the level adjuster, for performing a de-repetition on the set of adjusted values stored in the repetition buffer to re-generate the data.

6. The apparatus of claim 5, wherein each adjusted value output by the level adjuster is represented by i bits, and each adjusted value buffered in the repetition buffer is represented by j bits, where i≧j.

7. The apparatus of claim 1, wherein the equalizer equalizes a first and a second received signal to generate a first and a second equalized signal respectively; the de-mapper de-maps the first and the second equalized signals to generate a first and a second set of values representing data embedded in the first and the second received signals respectively; the level adjuster generates a first and a second adjusting factor according to noise levels of the first and the second received signals, and adjusts the first and the second sets of values according to the first and the second adjusting factors to generate a first and a second set of adjusted values respectively; and the combining circuit comprises:
an HARQ buffer, coupled to the level adjuster, for buffering the first set of adjusted values; and
a first computing unit, coupled to the HARQ buffer and the level adjuster, for performing a chase combining on the first set of adjusted values stored in the HARQ buffer and the second set of adjusted bits to re-generate the data embedded in the received signal.

8. The apparatus of claim 7, wherein the second received signal corresponds to a retransmission of the first received signal.

9. The apparatus of claim 7, wherein the first computing unit generates a first bit of the data according to a first bit of the first set of adjusted values and a first bit of the second set of adjusted values, and generates an n^{th} bit of the data according to an n^{th} bit and an (n−1)^{th} bit of the first set of adjusted values, an n^{th} bit and an (n−1)^{th} bit of the second set of adjusted values, and an (n−1)^{th} bit of an output of the first computing unit, where n is an integer larger than 1.

10. The apparatus of claim 7, wherein the combining circuit further comprises:
a repetition buffer, coupled to the level adjuster, for buffering adjusted values generated from the level adjuster; and
a second computing unit, coupled to the level adjuster, the repetition buffer, the HARQ buffer and the first computing unit, for performing a de-repetition on the adjusted values stored in the repetition buffer before the adjusted values are sent to the HARQ buffer.

11. The apparatus of claim 10, wherein each adjusted value output by the level adjuster is represented by i bits, each adjusted value buffered in the repetition buffer is represented by j bits, and each adjusted value buffered in the HARQ buffer is represented by k bits, where i≧j≧k.

12. A method for re-generating data from at least one received signal, comprising:
equalizing at least one received signal to generate at least an equalized signal;
de-mapping the equalized signal to generate a set of values representing data embedded in the received signal;
generating an adjusting factor according to a noise level of the received signal, and adjusting the set of values according to the adjusting factor to generate a set of adjusted values; and
performing a data combining on the set of adjusted values to re-generate the data embedded in the received signal.

13. The method of claim 12, wherein the step of equalizing at least one received signal to generate at least an equalized signal comprises:
equalizing a plurality of received signals received by a plurality of antennas to generate a plurality of equalized signals; and
adjusting at least one equalized signal according to the noise level before the equalized signal is combined with at least one other equalized signal and de-mapped.

14. The method of claim 12, wherein the noise level is derived from an RF error vector magnitude (EVM) table, pilot bits and data bits of the received signal.

15. The method of claim 12, wherein the adjusting factor is a reciprocal of a noise variance, and the step of adjusting the set of values comprises multiplying the set of values by the adjusting factor.

16. The method of claim 12, wherein the step of performing the data combining on the set of adjusted values comprises:
buffering the set of adjusted values; and
performing a de-repetition on the buffered adjusted values to re-generate the data.

17. The method of claim 16, wherein each adjusted value is represented by i bits, and each buffered adjusted value is represented by j bits, where i≧j.

18. The method of claim 12, wherein the step of equalizing at least one received signal comprises equalizing a first and a second received signal to generate a first and a second equalized signal respectively; the step of de-mapping the equalized signal comprises de-mapping the first and the second equalized signals to generate a first and a second set of values representing data embedded in the first and the second received signals respectively; the step of generating the adjusting factor comprises generating a first and a second adjusting factor according to noise levels of the first and the second received signals respectively; the step of adjusting the set of values comprises adjusting the first and the second sets of values according to the first and the second adjusting factors to generate a first and a second set of adjusted values respectively; and the step of performing the data combining on the sets of adjusted values comprises:
buffering the first set of adjusted values in an HARQ buffer; and
performing a chase combining on the buffered first set of adjusted values and the second set of adjusted values to re-generate the data embedded in the received signal.

19. The method of claim 18, wherein the second received signal corresponds to a retransmission of the first received signal.

20. The method of claim 18, wherein the step of performing the chase combining on the buffered first set of adjusted values and the second set of adjusted values comprises generating a first bit of the data according to a first bit of the first set of adjusted values and a first bit of the second set of adjusted values, and generating an n^{th} bit of the data according to an n^{th} bit and an (n−1)^{th} bit of the first set of adjusted values, an n^{th} bit and an (n−1)^{th} bit of the second set of adjusted values, and an (n−1)^{th} bit of the data generated after performing the chase combining, where n is an integer larger than 1.

21. The method of claim 18, wherein the step of performing the data combining on the set of adjusted values further comprises:
buffering adjusted values generated from adjusting the set of values in a repetition buffer; and
performing a de-repetition on the adjusted values stored in the repetition buffer.

22. The method of claim 21, wherein each adjusted value is represented by i bits, each adjusted value buffered in the repetition buffer is represented by j bits, and each adjusted value buffered in the HARQ buffer is represented by k bits, where i≧j≧k.
